(19) United States
(12) Patent Application Publication
(10) Pub. No.: US 2025/0131849 A1
(43) Pub. Date: Apr. 24, 2025

(54) ACTIVE BELT SYSTEM AND SIMULATOR

(71) Applicant: REBEL DYNAMICS S.R.L., Lecco (IT)

(72) Inventors: Giovanni TODESCHINI, Lecco (IT); Francesco LA MURA, Lecco (IT)

(21) Appl. No.: 18/690,525

(22) PCT Filed: Aug. 31, 2022
(86) PCT No.: PCT/IB2022/058149

§ 371 Date: Mar. 8, 2024

(30) Foreign Application Priority Data
Sep. 10, 2021 (IT) 102021000023453

(51) Int. Cl. G09B 9/02

(52) U.S. Cl. CPC G09B 9/02

(57) ABSTRACT

Provided is an active belt system for transmitting loads onto a driver during simulation of a vehicle in a simulator having a first upper belt and a second upper belt embracing the driver, a closing mechanism constraining the first and second upper belts, and a connection system provided with a rear belt element having a right end engageable with the first upper belt, and a left end engageable with the second upper belt, so that the rear belt element embraces the driver passing from the driver's back. Side belts are joined to the rear belt element. An actuation system applies a controllable load to the first and second upper belts and to the connecting system to actively modify length of the first and/or second upper belts and the connection system, modifying accordingly loads transmitted to the driver. A simulator comprising a frame, a seat and the active belt system is also provided.

The present invention relates to an active belt system for transmitting inertial loads onto a driver or a passenger of a vehicle during a simulation in simulator, for example during a driving simulation of a vehicle in a simulator or, more generally, to a passenger of a vehicle, for example a passenger of an attraction vehicle belonging to an amusement park, an aerospace vehicle and the like, to be simulated by means of a suitable vehicle simulator.

Generally, vehicle simulators adopt technological solutions and robotic systems so as to transmit onto the driver or passenger dynamic stimuli that imitate the behavior of the vehicle as faithfully as possible.

One of the most critical aspects of these systems is the need to also transfer to the driver/passenger the inertial loads caused by vehicle accelerations at a low frequency and when static. Insofar as the transmission of these loads is difficult to manage, most simulators sacrifice these components simply by filtering them.

However, there are systems that attempt to transmit these components as well, but sometimes with some drawbacks.

Some systems, which are mainly intended for an elite market, use the movement of one or more robotic systems connected to the driving position. Since it is necessary to transmit accelerations for prolonged periods, these devices require a significant dynamic performance, combined with extremely long strokes. In particular, these devices are rather cumbersome and involve the installation of high-power systems and at a high cost that is often not justified by the performance which, in most cases, is inadequate for the intended purposes.

A second solution that is less expensive and simpler than the former involves the transmission of direct body stimuli based on the desired inertial forces. This mode makes it possible for forces to be transferred to the driver's body in certain directions, even for indefinite periods of time, and, typically, it is performed by means of active devices in the seats and/or by means of implemented safety belts.

The use of active devices in the seats may involve the use of one or more pneumatic cushions, which are inserted into specific recesses located inside the seat padding of the simulator and implemented by means of compressed air and electronically controlled valve systems.

However, such solutions present some problems.

Inconveniently, the pneumatic systems used have limited response times and poor modulation regarding the forces transmitted.

Furthermore, the points of contact between the seat and the driver do not always reflect that which the driver perceives during actual driving: the driver experiences a potentially correct force, in terms of the result, but one that is inconsistent from the tactile point of view of the interaction with the seat, and this may compromise the overall effect of the simulation.

Moreover, inconveniently, these systems: may be influenced by the shape of the seat and the padding for the housing, to the detriment of the effectiveness and versatility thereof.

Other solutions on the market achieve the transmission of loads to the driver by adopting mobile mechanical systems that are integral or internal to the seat, instead of pneumatic padding. For example, some of the contact surfaces between the driver and the seat are replaced with actuated panels that are capable of translating and/or rotating. The combined action of these panels is capable of pushing the body of the driver in specific directions.

Disadvantageously, even these solutions do not generate optimal tactile feedback.

Furthermore, inconveniently, such solutions have a decidedly high complexity and cost, and require substantial modifications to the seat, at the expense of versatility and adaptability to different seats.

An alternative to solutions that make use of active seats is the use of active safety belt systems, hereinafter referred to, for simplicity, as “active belt systems”.

The active belt systems of the prior art employ motorsport safety belts as a starting point, combined for safety and immersion reasons with more or less restrained sports seats. Safety belts that are commonly used in actual racing cars consist of belts, usually made of technical fabric, in a number that may vary from four to six, with which there are associated an equal number of anchoring points (indeed usually from four to six). The term anchorage points refers to those points where such safety belts in the motorsport sector are fastened to the frame of the vehicle or to the internal protective roll bars.

These belts are adjustable in length by means of special buckles and are provided with terminations that allow, at one end, attachment to the frame or roll bar of the vehicle, and at a second end, insertion into a closing mechanism.

In particular, motorsport safety belts with a four-point layout include two upper belts, which pass over the shoulders of the driver, down onto the chest, up to the abdomen, and two central belts that surround the driver at the pelvis area.

Motorsport safety belts with a 6-point layout also include two additional, lower belts that pass between the driver's legs.

Those solutions that are known in the field of active belt systems for simulators envisage maintaining the shape, number and arrangement of the original belts of the safety belts described above while implementing different forms of application, with the aim of tensioning one or more of the upper belts of such layouts. Such systems also passively adjust the length of the belts by means of buckles, while one or more fixed anchoring points may optionally be replaced with connections to yielding elements, for example springs. In this way, the relative movement between the seat and the belts applies a certain force, typically of longitudinal compression, to the torso of the driver.

Alternative systems only provide for the implementation of belts that also keep the seat fixed.

The more modular and versatile systems provide a dedicated tensioning system associated with each upper belt and/or each central belt.

The aforementioned known solutions are effective for the transfer of inertial loads due to the longitudinal dynamics of the vehicle, but are disadvantageously incapable of transferring lateral loads.

Inconveniently, moreover, the contact surface with the driver through which the loads are transmitted is extremely small, and consequently the distribution of pressures during the simulation is not homogeneous or representative of reality.

Consequently, the tactile feedback of the load is ineffective and inconsistent with that which happens in reality.

The need is therefore strongly felt to propose a system of active belts that are capable of overcoming the drawbacks cited with reference to the prior art. In particular, the need is felt to increase the immersiveness of the driving simulation and to improve the performance, for the driver/passenger, of static and low-frequency inertial loads, especially in the lateral direction.

These requirements are met by an active belt system and simulator according to the attached independent claims. The dependent claims describe preferred or advantageous embodiments of the invention.

The features and advantages of the active belt system and simulator will become apparent from the description below of some preferred embodiments thereof, given for illustrative and non-limiting purposes, with reference to the attached figures, wherein:

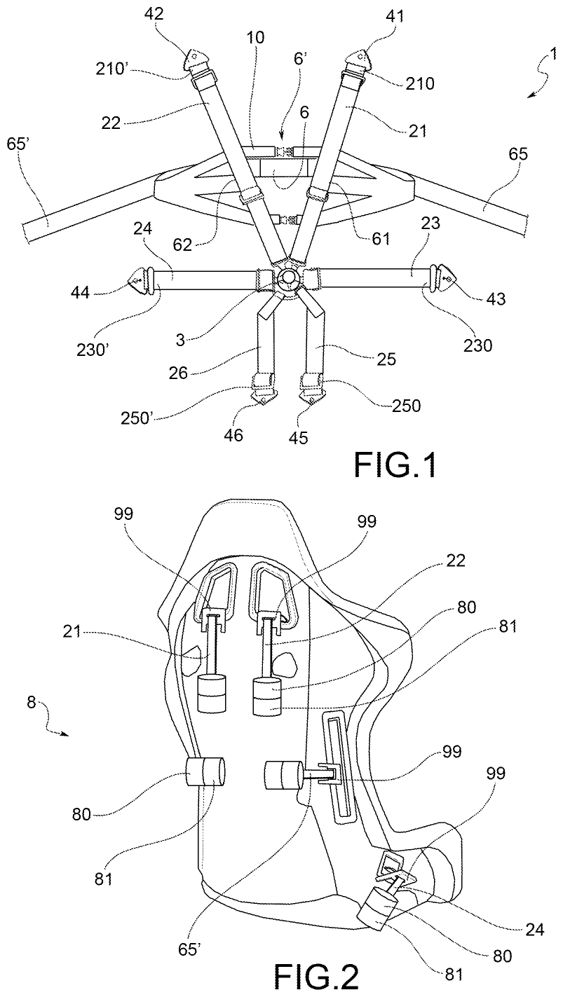

FIG. 1 shows a front view of an active belt system according to an embodiment of the present invention;

FIG. 2 shows a perspective view of a seat to which an active belt system is constrained according to an embodiment of the present invention;

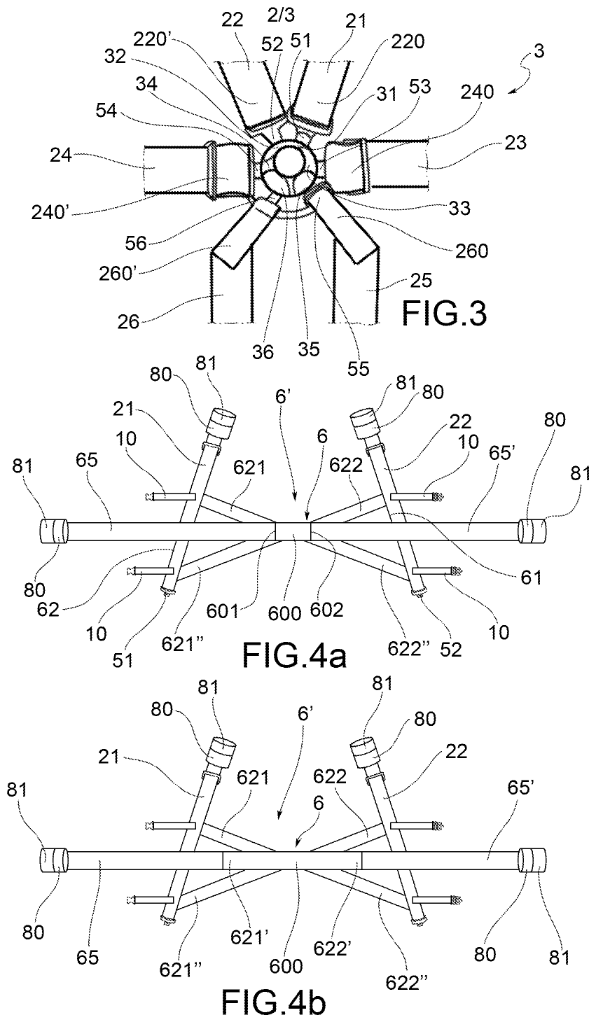

FIG. 3 shows a detailed view of the closing mechanism shown in FIG. 1;

FIG. 4a shows a rear view of a connection system of an active belt system according to an embodiment of the invention;

FIG. 4b shows a rear view of a connection system of an active belt system according to an alternative embodiment of the invention;

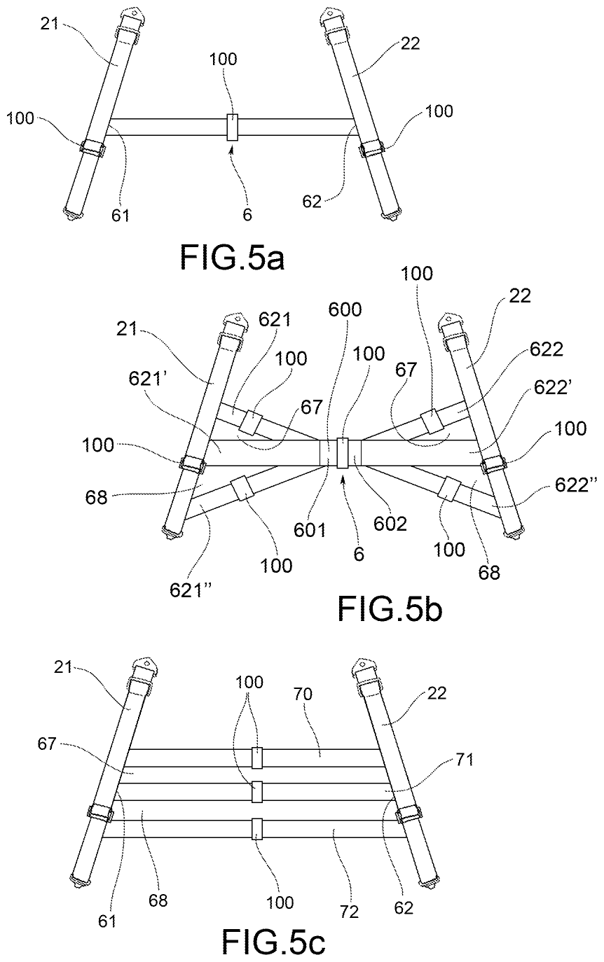

FIGS. 5a, 5b and 5c show a rear view of a rear belt element according to three alternative embodiments of the invention.

With reference to the above: reference number 1 indicates, in the entirety thereof, an active belt system for the transmission of loads onto a passenger or driver during a simulation of a vehicle in a simulator.

In accordance with the invention, and with reference to the attached FIG. 1, the active belt system comprises:
a first upper belt 21 and a second upper belt 22;
a closing mechanism 3;
a connection system 6′, comprising in turn a rear belt element 6 and side belts 65, 65′.

The aforementioned first and second upper belts 21, 22 are suitable for embracing the driver, passing from the shoulders down onto the chest, up to the abdomen.

Each of these first and second upper belts comprises at a respective lower end 220, 220′ respectively a first closing terminal 51 and a second closing terminal 52.

The closing mechanism 3 comprises a first and a second closing seat 31, 32 suitable for accommodating the first 51 and the second closing terminal 52.

Preferably, each of said first and second upper belts 21, 22 comprises at a respective lower end 210, 210′ respectively a first coupling terminal 41 and a second coupling terminal 42.

Preferably, such first and second coupling terminals 41, 42 are suitable for being fastened to the frame of the simulator or to one of the adjustment elements 80.

In accordance with the invention, the connection system 6′, as already mentioned, consists of:
a rear belt element 6 having a right end 61, which is engageable with the first upper belt 21, and a left end 62, which is engageable with the second upper belt 22, so that said rear belt element 6 is suitable for embracing the driver passing from the back;
side belts 65, 65′, joined to the rear belt element 6 at any point between said right and left ends 61, 62.

According to one embodiment, the side belts are attached to the rear belt element 6 at any point between said right and left ends 61, 62, excluding the right and left ends 61, 62 themselves.

Preferably, the closing mechanism 3 also comprises a quick release system that releases each of said first and second closing seats 31, 32 from the engagement with said first and second closing terminals 51, 52.

According to the invention, said active belt system 1 comprises an actuation system 8 that is suitable for controlling a load on each of the first and/or second upper belts 21, 22 and on the connection system 6′.

The actuation system 8 comprises adjustment elements 80 and active means 81, that are suitable for actuating the aforementioned adjustment elements 80, so as to actively modify the length of the first upper belt 21 and/or the second upper belt 22 and of the connection system 6′, thus modifying the loads transmitted to the driver.

Preferably, the adjustment elements 80 are motorized buckles, or motorized spools, or drums, or active slides.

Preferably, the active means 81 are rotary electric motors, or gearmotors, or linear motors, or pneumatic pistons, or hydraulic pistons operatively connected to the adjustment elements 80 to modify the length of each of said first and second upper belts 21, 22 and of the connection system 6′.

According to an advantageous embodiment, each of the side belts 65, 65′ is suitable for being bound at a respective free end to one of the adjustment elements 80 and the active means 81 are suitable for actuating said adjustment elements 80, so as to actively modify the length of each of the side belts 65, 65′.

In other words, preferably, the actuation system 8 acts on the transmission of the loads onto the driver in directly shortening or lengthening the side belts 65, 65′. Preferably, therefore, the actuation system 8 acts on the rear belt element 6 indirectly, passing from the modification of the length of the side belts 65, 65′.

According to an embodiment of the invention, for example illustrated in FIG. 5a, the rear belt element 6 is a single belt element that extends along a preferred direction, extending between the right and left ends 61, 62.

According to an alternative embodiment, for example illustrated in the attached FIG. 5b, the rear belt element 6 comprises:
a central portion 600, delimited by a first and a second crossing end 601, 602;
first divergent belt elements 621, 621′, 621″, extending between said first crossing end 601 and the right end 61;
second divergent belt elements 622, 622′, 622″, extending between said second crossing end 602 and the left end 62;
wherein said first 621, 621′, 621″ and second divergent belt elements 622, 622′, 622″ develop radially respectively from said first 601 and second crossing end 602 and identify, respectively with the first 21 and with the second upper belt 22, crossed surfaces suitable for coming into contact with the driver's hips.

Preferably, said crossed surfaces are “V”-shaped.

According to an embodiment of the invention, with reference to FIG. 4a, the side belts 65, 65′ are joined to the rear belt element 6 at the aforementioned first and second crossing ends 601, 602.

According to an alternative embodiment, with reference to FIG. 4b, the side belts 65, 65′ are joined to the rear belt element 6 at the middle of the crossed surfaces.

According to an advantageous embodiment, the connection system 6′ comprises filling portions 67, 68, for example made of fabric, arranged between said first divergent belt elements 621, 621′, 621″ and said first upper belt 21, and between said second divergent belt elements 622, 622′, 622″ and said second upper belt 22, respectively, so as to maximize the area of said crossed surfaces that are in contact with the driver's hips.

According to a further embodiment of the invention, illustrated in FIG. 5c, the rear belt element 6 comprises multiple belts 70, 71, 72. Said multiple belts 70, 71, 72 extend on mutually parallel preferential extension directions and between said left and right ends 61, 62, so that with said first and second upper belts 21, 22), said multiple belts 70, 71, 72 identify a rear surface suitable for coming into contact with the driver's back and hips.

Preferably, said multiple belts 70, 71, 72 are spaced therebetween along a direction perpendicular to the preferential extension directions parallel therebetween.

According to an advantageous variant, the connection system 6′ comprises filling portions 67, 68, for example made of fabric, arranged between said multiple belts 70, 71, 72 so as to maximize the area of said rear surface.

Preferably, the right and left ends 61, 62 of the rear belt element 6 are respectively immovably engageable with, for example sewn to, said first and second upper belts 21, 22.

Alternatively, the right and left ends 61, 62 of the rear belt element 6 are respectively removably engageable, for example by means of buckles, with said first and second upper belts 21, 22.

Preferably, the active belt system 1 comprises mechanical locking devices suitable for establishing a maximum length of each of said first and second upper belts 21, 22 and of the connection system 6′, so as to limit the action of the adjusting elements 80.

Preferably, the actuation system 8 is suitable for operating in a unilateral configuration, in which the adjusting elements 80 are suitable for reducing the length of said first and second upper belts 21, 22 and of the connection system 6′, increasing the loads transmitted to the driver with respect to a predetermined preload situation on the driver/passenger.

Alternatively, the actuation system 8 is suitable for operating in a bilateral configuration, in which the adjusting elements 80 are suitable both for reducing and increasing the length of each of said first and second upper belts 21, 22, and of the connection system 6′, preferably at most up to the maximum length established by the mechanical locking devices. In this way, it is possible to respectively increase or reduce the loads transmitted to the driver/passenger with respect to a predetermined preload situation on the driver/passenger.

According to an embodiment, the actuation system 8 comprises an electronic processing and control unit configured to control the active means 81 in such a way as to increase and/or reduce the length of said first and second upper belts 21, 22 and of the connection system 6′ with respect to a predetermined length of said first and second upper belts 21, 22 and of the connection system 6′ that determines the preload on the driver/passenger.

According to an embodiment, shown for example in FIG. 1, the active belt system 1 also comprises a first central belt 23 and a second central belt 24, suitable for embracing the driver passing above the pelvis.

Each of said first and second upper belts 23, 24 comprises at a respective lower end 240, 240′, a first central coupling terminal 53 and a second central coupling terminal 54 respectively.

According to such an embodiment, the closing mechanism 3 therefore comprises a third and a fourth closing seat 33, 34 engageable with said first and second central coupling terminal 53, 54.

These central belts 23, 24 may also be implemented by the actuation system 8, or else passively contribute to the transmission of the loads to the driver/passenger and be constrained to the frame.

In particular, preferably, the first central belt 23 and the second central belt 24 comprise at a respective distal end 230, 230′ respectively a first central coupling terminal 43 and d a second central coupling terminal 44.

Said first and second central coupling terminals 43, 44 are suitable for being fastened to the simulator frame, or to one of the adjustment means 80, and the active means 81 are suitable actuating said adjustment elements 80, so as to actively modify the length of the first central belt 23 and/or the second central belt 24.

According to a further embodiment, the active belt system 1 also comprises a first lower belt 25 and a second lower belt 26, suitable for embracing the driver passing between the legs.

In particular, each of said first and second lower belts 25, 26 comprises at a respective lower end of the lower belt 250, 250′ respectively a first lower coupling terminal 45 and a second lower coupling terminal 46, suitable for being fastened to the simulator frame or seat.

Each of said first and second lower belts 25, 26 is constrained to the closing mechanism 3.

In particular, preferably, each of said first and second lower belts 25, 26 comprises at a respective upper end of the lower belt 260, 260′ respectively a first lower closing terminal 55 and a second lower closing terminal 56; according to this embodiment, the closing mechanism 3 comprises a fifth and a sixth closing seat 35, 36 engageable by snapping with said first and second lower closing terminals 55, 56.

According to this embodiment, therefore, the closing mechanism may be released from the lower belts, which instead remain constrained to the frame or the seat.

Alternatively, each of said first and second lower belts 25, 26 is permanently constrained, for example irremovably fastened, to the closing mechanism 3.

In other words, according to this variant the lower belts are formed as one with the closing mechanism, and may not be disengaged therefrom.

By means of these lower belts, the closing mechanism is therefore forced to remain constrained to the frame or seat.

According to a variant embodiment, for example shown in FIGS. 1, 4a and 4b, the active belt system 1 also comprises auxiliary connections 10, suitable for connecting the first 21 and the second upper belt 22 to each other, passing on the driver's chest.

Preferably, the active belt system 1 also comprises manual adjustment means 100, for example sliding buckles, for each of said first and second upper belts 21, 22, and for the rear belt element 6.

These manual adjustment means 100 are suitable for being manipulated to manually modify the length of each of said first and second upper belts 21, 22 and of the rear belt element 6.

Such manual adjustment means are preferably suitable for being manipulated to manually modify the length also of each of said first and second central belts 23, 24, and of each of said first and second lower belts 25, 26.

With reference to the embodiment t illustrated in FIG. 2, the active belt system 1 comprises belt guide elements 99, for example brackets with belt guides with a single or double roller, suitable for being fastened to the seat or frame of a simulator and suitable for stabilizing the sliding of each of said first and second upper belts 21, 22, and of said connection system 6′, so as to keep the direction in which the adjustment means 80 act constant.

According to one embodiment, the closing mechanism 3 is suitable for being anchored to at least one anchoring point integral with the simulator frame or seat. In particular, the locking mechanism 3 is constrained at least partially in a non-actively adjustable manner, for example by a connection with the seat or with the simulator frame by means of belts that are only passively adjustable using manual adjustment means. Such only passively adjustable belts may be one or more of said first and second central belts 23, 24 or of said first and second lower belts 25, 26.

The subject of this invention is also a simulator comprising a frame, a seat and at least one active belt system 1 according to this invention and described in the preceding paragraphs.

Preferably, the simulator is equipped with displays and actuators, of themselves known to an expert in the field and as such not described here.

For example, the simulator is a simulator for driving a wheeled vehicle, or an aerospace vehicle, or a means of naval transport or similar. Alternatively, the simulator is for example a system capable of simulating the loads on a passenger sitting on the seat of a roller coaster, or on the seat of a 4D cinema.

Innovatively, the present invention brilliantly overcomes the drawbacks of the systems of the prior art.

Innovatively, in fact, the present invention makes it possible to transfer to a passenger sitting on a seat a resulting force with vertical, longitudinal and above all lateral components, considerably increasing the immersiveness of the simulation.

Advantageously, moreover, the present invention improves the ability of any simulator to allow the driver to perceive static and low frequency inertial loads.

Advantageously, the present invention makes the simulation n more faithful to the transmission of loads during the actual use of the vehicle. In fact, the active belt system which is the object of the invention does not make use of active elements inside the vehicle seat, and uses the belts only as a means of stimulation. The seat acts passively as a means of containment for the driver and as a source of constraining reactions, as happens under actual normal dynamics.

Conveniently, therefore, this invention is adaptable for use with different seats, and requires minimal modifications to the seats in order to allow for the passage of the side belt elements.

In particular, in an extremely advantageous way, the present invention makes it possible to apply an adjustable force on the driver's torso, especially by virtue of the rear belt element 6 and even more effectively by virtue of the side belts 65, 65′.

According to a further advantage, the active belt system according to the invention, by virtue of the synergistic combination of the actuation system 8 and the addition of the connection system 6′, makes it possible to apply independent forces on each belt in order to obtain a resultant force that is directed arbitrarily in any direction aimed at the seat.

According to an even further advantage, the active belt system makes it possible to generate a force wherein the components thereof are modulated continuously and with a wide range of amplitude and with low latency, transferring to the driver a combination of dynamic, static and low frequency feedback.

Innovatively, the present invention improves the tactile rendering of the transmission of forces in the lateral direction.

Advantageously, the presence of mechanical locking systems makes it possible to maintain the functionality of safety belts, especially the ability to effectively hold the torso in the case of an emergency.

Advantageously, the actuation system acting in a dedicated manner on each belt of the active belt system which is the object of the invention increases the readiness and coordination between the different systems on the market.

Advantageously, the variant of the connection system with crossings and filling portions makes it possible to maximize the contact surface with the hips of the driver/passenger, improving the distribution of the pressures and inertial loads.

Advantageously, the filling portions ensure greater ergonomics and resistance for the connection system.

Conveniently, furthermore, the belt guide elements provide support to the belts and generate a constant pulling direction.

Advantageously, finally, such an invention is capable of significantly improving the effectiveness of a driving simulator and radically influencing the operation thereof. The initial description of the prior art shows how known simulators are strongly influenced in design, cost and performance by the problems solved by the invention in question. As a result, the active belt system herein described, when adopted in a simulator, may radically influence the design specifications, final performance, design and cost thereof.

A person skilled in the art may, in order to meet specific needs, make several changes to the embodiments of this invention or substitutions of elements with others that are functionally equivalent.

These variants are also contained within the scope of protection as defined by the following claims.

1. An active belt system for transmitting loads onto a passenger or a driver during a simulation of a vehicle in a simulator, comprising
a first upper belt and a second upper belt, suitable for embracing the driver, passing from shoulders down onto a chest, up to an abdomen of the driver, each of said first and second upper belts comprising, at a respective lower end, a first closing terminal and a second closing terminal, respectively;
a closing mechanism, comprising a first closing seat and a second closing seat engageable with said first and second closing terminals;
a connection system, comprising
a rear belt element comprising a right end engageable with the first upper belt, and a left end engageable with the second upper belt, so that said rear belt element is suitable for embracing the driver passing from a back of the driver;
side belts, joined to the rear belt element in any point between said left and right ends;
wherein said active belt system further comprises an actuation system suitable for applying a controllable load to each of said first and second upper belts and to said connection system, and wherein the actuation system comprises adjustment elements and active means, suitable for actuating said adjustment elements, so as to actively modify a length of the first upper belt and/or the second upper belt and of the connection system, thus modifying the loads transmitted to the driver.

2. The active belt system of claim 1, wherein each of said first and second upper belts comprises, at a respective upper end a first coupling terminal and a second coupling terminal, respectively, said first and second coupling terminals being suitable for being fastened to a frame of the simulator or to one of the adjustment elements.

3. The active belt system of claim 1, wherein each of the side belts is suitable for being constrained, at a respective free end, to one of the adjustment elements, and wherein the active means are suitable for actuating said adjustment elements, so as to actively modify a length of each of the side belts.

4. The active belt system of claim 1, wherein the rear belt element is a single belt element extending along a preferential extension direction between said left and right ends.

5. The active belt system of claim 1, wherein the rear belt element comprises:
a central portion delimited by a first crossing end and a second crossing end;
first divergent belt elements, extending between said first crossing end and the right end; and
second divergent belt elements, extending between said second crossing end and the left end;
wherein said first and second divergent belt elements extend in a radial pattern from said first and second crossing ends, respectively, and with said first and second upper belts, respectively, identify crossed surfaces suitable for coming into contact with hips of the driver.

6. The active belt system of claim 5, wherein said connection system comprises filling portions, arranged between said first divergent belt elements and said first upper belt, and between said second divergent belt elements and said second upper belt, respectively, such as to maximize an area of said crossed surfaces.

7. The active belt system of claim 1, wherein the rear belt element comprises multiple belts, extending on mutually parallel preferential extension directions and between said left and right ends, so that with said first and second upper belts, said multiple belts identify a rear surface suitable for coming into contact with the driver's back and hips.

8. The active belt system of claim 7, wherein said connection system comprises filling portions arranged between said multiple belts, such as to maximize an area of said rear surface.

9. The active belt system of claim 1, further comprising mechanical locking devices suitable for establishing a maximum length of each of said first and second upper belts, and of the connection system, so as to limit an action of the adjustment elements.

10. The active belt system of claim 1, wherein the actuation system is suitable for operating in a unilateral configuration, in which the adjustment elements are suitable for reducing the length of each of said first and second upper belts, and of the connection system, increasing the loads transmitted to the driver or the passenger with respect to a predetermined preload situation on the driver or the passenger.

11. The active belt system of claim 1, wherein the actuation system is suitable for operating in a bilateral configuration, in which the adjustment elements are suitable both for reducing the length of each of said first and second upper belts, and of the connection system, and for increasing the length of each of said first and second upper belts and of the connection system, so as to increase or reduce, respectively, the loads transmitted to the driver or the passenger with respect to a predetermined preload situation on the driver or the passenger.

12. The active belt system of claim 1, further comprising a first central belt and a second central belt, suitable for embracing the driver passing above a pelvis of the driver, wherein the first central belt and the second central belt comprise, at a respective distal end, a first central coupling terminal and a second central coupling terminal, respectively, said first and second central coupling terminals being suitable for being fastened to a frame of the simulator, or to one of the adjustment elements, and wherein the active means are suitable for actuating said adjustment elements, so as to actively modify a length of the first central belt and/or the second central belt.

13. The active belt system of claim 1, further comprising a first lower belt and a second lower belt, suitable for embracing the driver passing between legs of the driver, each of said first and second lower belts comprising, at a respective lower end, a first lower coupling terminal and a second lower coupling terminal, respectively, said first and second lower coupling terminals being suitable for being fastened to a frame or to a seat of the simulator, and wherein each of said first and second lower belts is constrained to the closing mechanism.

14. The active belt system of claim 1, further comprising manual adjustment means for each of said first and second upper belts, and for the rear belt element, said manual adjustment means being suitable for being manipulated to manually modify the length of each of said first and second upper belts and of the rear belt element.

15. The active belt system of claim 1, further comprising belt guide elements suitable for being fastened to a seat or a frame of the simulator, and for stabilizing sliding of each of said first and second upper belts, and of said connection system, so as to keep a direction in which the adjustment elements act constant.

16. A simulator, comprising
a frame,
a seat, and
the active belt system of claim 1, wherein the active bel system is suitable for cooperating with the frame and/or the seat.

17. The active belt system of claim 6, wherein said filling portions are made of fabric.

18. The active belt system of claim 14, wherein the manual adjustment means are sliding buckles.

19. The active belt system of claim 15, wherein the belt guide elements are brackets with belt guides with a single or a double roller.
